(19) United States
(12) Patent Application Publication
(10) Pub. No.: US 2017/0082551 A1
(43) Pub. Date: Mar. 23, 2017

(54) MOBILE MICROFLUIDIC DETERMINATION OF ANALYTES

(71) Applicant: SCHLUMBERGER TECHNOLOGY CORPORATION, Sugar Land, TX (US)

(72) Inventors: Bruce Alexander MACKAY, Sugar Land, TX (US); Farshid MOSTOWFI, Edmonton (CA); Vincent SIEBEN, Edmonton (CA); Cedric FLOQUET, Edmonton (CA)

(21) Appl. No.: 15/126,225

(22) PCT Filed: Mar. 26, 2015
(86) PCT No.: PCT/US2015/022664

§ 371 Date: Sep. 14, 2016

Related U.S. Application Data
(60) Provisional application No. 61/971,960, filed on Mar. 28, 2014.

(51) Int. Cl. G01N 21/78; B01F 13/00; B01F 3/12; B01L 3/00

(52) U.S. Cl. CPC G01N 21/78; B01L 3/5027; B01F 13/0059; B01F 3/1207; G01N 2021/0346

(57) ABSTRACT

A method includes providing a water sample for analysis at a well site, or at a location proximate the well site, where the water sample is collected from at least one water source and the water sample comprises at least one analyte. The water sample and a reagent are introduced into a microfluidic mixing cell to produce a mixture of the reagent and water sample, and the mixture has a detectable characteristic indicative of concentration of the at least one analyate in the water sample. The detectable characteristic is measured by spectrophotometry to determine concentration of the at least one analyte. Then a subterranean formation treatment fluid is prepared using water from the at least one water source based on the concentration of the at least one analyte. The introducing into the microfluidic mixing cell and the measuring by spectrophotometry are conducted over an elapsed time period of about 5 minutes or less.

### RELATED APPLICATION INFORMATION

This application claims the benefit of U.S. Provisional Application No. 61/971,960 filed Mar. 28, 2014, which is incorporated herein in its entirety.

### BACKGROUND

The statements in this section merely provide background to facilitate a better understanding of the various aspects of the disclosure and may not constitute prior art. It should be understood that the statements in this section of this document are to be read in this light.

Water sourced from one or more sources, can be a component used in many oil and gas field operations. Water may be transported to the oilfield site for various purposes, including drilling mud, formation fracturing, acidizing, enhanced oil recovery including steam injection, and the like. In addition to the desired hydrocarbons, many oil and natural gas producing wells also generate large quantities of waste water, commonly referred to as “produced water.” Produced water may, in some cases, include chemicals and other substances requiring that the produced water be analyzed and/or treated before being reused or discharged to the environment. In some instances, the components may include drilling mud, or “fracturing flow back water” that may contain spent fracturing fluids including polymers and inorganic cross-linking agents, friction reducers, and the like.

Economic factors connected with transporting uncontaminated water to the well site and the typically abundant supply of produced water generated on site, it is often desirable to reuse the produced water in production operations at the well site. For example, produced water can be typically used in production stimulation treatment, which involves in one method fracturing the formation utilizing a viscous treating fluid, typically a fracturing gel, wherein the subterranean formation or producing zone is hydraulically fractured and whereby one or more cracks or “fractures” are produced. In such a method, the produced water may be used as fracturing feed water. A fracturing gel is created by combining the feed water with a polymer, such as guar gum, and in some applications a cross-linker, typically borate-based or zirconium-based, to form a fluid that gels, or increases in viscosity, at desired points during the stimulation treatment. Several additives maybe added to form a treatment fluid specifically designed for the anticipated wellbore, reservoir and operating conditions.

Contaminant species laden in the source water, as well as different quality of water from different sources, often requires the source to be analyzed to determine the species and other impurities present. The types and concentrations of the species or other impurities may typically influence the treatment to be applied and/or additives mixed to the source water to create a stimulation fluid having the specific properties required to properly treat the intended formation. In a conventional process, a sample of the source water is subject to laboratory analysis and subsequently a stimulation fluid formulation is created based on the analysis of the source water sample. Generally, personnel specifically trained to operate the extensive laboratory equipment must be employed to accurately analyze the production water sample. Additionally, such laboratory equipment typically requires extensive technical support, sufficient infrastructure, transportation means when used on site, and sufficient space to operate. Such space may be unavailable, particularly on wellsite facilities, where additional space requires substantial economic investment in the platform, drilling pad or rig. Furthermore, additional manpower required to operate the laboratory equipment offshore can result in higher operating costs for the operator of the well. Thus, the water sample is typically analyzed in a laboratory setting offsite.

Another problem associated with the submission of source water samples for analysis, particularly to an offsite laboratory, is the length of time required to obtain verification of the sample composition. Such lengths of time cause a significant delay in oil/gas production while waiting for a source water sample to arrive at the laboratory, and for the laboratory to process the sample. Inductively Coupled Plasma Mass Spectrometry (ICP-MS) instrumentation and wet chemistry techniques are commonly used, and ICP-MS requires the sample to be shipped to an offsite laboratory. Wet chemistry techniques require significant glassware, a well ventilated environment and fume-hood, and pose health and safety risks in the field. Wet chemistry techniques most often require numerous manipulations of fluids and glassware and need a trained operator to determine fluid properties (chemical or physical) in a precise and accurate manner.

Therefore, the need exists for methods that can reduce or eliminate operator errors, the number of offsite laboratory experiments needed to analyze source water, as well as techniques which enable real-time QA/QC of stimulation fluids, so that the treatment may be adjusted if needed. Techniques which achieve the above would be highly desirable, and these needs are met at least in part by the following disclosure.

### SUMMARY

This section provides a general summary of the disclosure, and is not a necessarily a comprehensive disclosure of its full scope or all of its features.

In a first aspect of the disclosure, a method includes providing a water sample for analysis, where the water sample is collected from at least one water source and the water sample includes at least one analyte. The water sample and a reagent are introduced into a microfluidic mixing cell to produce a mixture of the reagent and water sample, and the mixture has a detectable characteristic indicative of concentration of the at least one analyate in the water sample. The detectable characteristic is measured by spectrophotometry to determine concentration of the at least one analyte. Then a subterranean formation treatment fluid is prepared using water from the at least one water source based on the concentration of the at least one analyte. The introducing into the microfluidic mixing cell and the measuring by spectrophotometry are conducted over an elapsed time period of about 5 minutes or less in some cases, or even over an elapsed time period of about 1 minutes or less. In some aspects, the mixture of the reagent and water sample is passed through an optical cell concurrent with the measuring the detectable characteristic by spectrophotometry. The specific location of carrying out methods according to the disclosure may be a well site, a location proximate the well site, a laboratory (mobile, stationary, or otherwise located), or any location suitable or practical for achieving the sample analysis. However, the specific location is non-limiting to embodiments of the disclosure.

In some further embodiments, the method is repeated as many times as appropriate, or even carried out on multiple mixing/measuring arrangements. As many arrangements as deemed appropriate may be used. To illustrate, the water sample and an Nth reagent may be introduced into a Nth microfluidic mixing cell to produce a mixture of the Nth reagent and water sample, the mixture having Nth detectable characteristic indicative of concentration of a Nth analyte in the water sample. The Nth detectable characteristic may be measured by spectrophotometry to determine the concentration of the Nth analyte, and a subterranean formation treatment fluid, containing water from the at least one water source, is prepared based on the concentration of the at least one analyte and the Nth analyte. The introducing into the microfluidic mixing cells and the measuring are conducted over an elapsed time period of about 5 minutes or less, or even over an elapsed time period of about 1 minutes or less.

The methodology may further include introducing the water sample into a rotating valve, passing the water sample through a sample loading loop fluidly connected with the rotating valve, and then passing the water sample and a reagent into the microfluidic mixing cell, where the elapsed time period between the introducing the water sample into the rotating valve and the measuring is about 5 minutes or less, or even about 1 minutes or less. In some cases, a carrier fluid pushes the water sample in the rotating valve and the sample loading loop prior to the introduction the water sample into the microfluidic mixing cell. In another aspect, the carrier fluid and the reagent are introduced into the microfluidic mixing cell to produce a mixture of the reagent and the carrier fluid, the mixture of the reagent and the carrier fluid measured by spectrophotometry to determine a baseline before measuring the water sample, and the mixture of the reagent and the carrier fluid is substantially free of the water sample. The introduction of carrier fluid and reagent into the microfluidic mixing cell as well as the measurement of the mixture may be conducted separate from the introducing the water sample and the reagent into the microfluidic mixing cell and the measuring the detectable characteristic. The measured baseline and the measured detectable characteristic may be compared to determine concentration of the at least one analyte.

In another aspect of the disclosure, methods include providing at least one water source, the at least one water source containing at least one analyte, then delivering an aqueous stream from the at least one water source to a mixer and to a microfluidic mixing cell, simultaneously or in any order. A water sample from the at least one water source and a reagent are introduced into a microfluidic mixing cell to produce a mixture of the reagent and water sample, and the mixture has a detectable characteristic indicative of concentration of the at least one analyate in the water sample. The detectable characteristic is measured by spectrophotometry to determine concentration of the at least one analyte, and one or more additive components are mixed in the mixer with the aqueous stream, in amounts based on the concentration of the at least one analyte measured. A treatment fluid is prepared afterward, which contains the at least one water source and the one or more additive components, and then injected into a wellbore penetrating a subterranean formation. The introducing into the microfluidic mixing cell and the measuring by spectrophotometry are conducted over an elapsed time period of about 5 minutes or less in some cases, or even over an elapsed time period of about 1 minutes or less. In some aspects, the mixture of the reagent and water sample is passed through an optical cell concurrent with the measuring the detectable characteristic by spectrophotometry.

Yet another aspect of the disclosure provides methods of preparing a subterranean formation treatment fluid by delivering an aqueous stream from at least one water source to a mixer, providing a water sample having at least one analyate from the at least one water source, and introducing the water sample and a reagent into a microfluidic mixing cell to produce a mixture of the reagent and water sample. The mixture has a detectable characteristic indicative of concentration of the at least one analyte in the water sample, and the detectable characteristic is measured by spectrophotometry to determine concentration of the at least one analyte. One or more additive components are added to the mixer and mixed with the aqueous stream, in an amount based on the concentration of the at least one analyte. A treatment fluid is prepared including the at least one water source and the one or more additive components, and thereafter pumped into a wellbore penetrating a subterranean formation. The introducing into the microfluidic mixing cell and the measuring by spectrophotometry are conducted over an elapsed time period of about 5 minutes or less in some cases, or even over an elapsed time period of about 1 minutes or less.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 illustrates a method for analyzing a sample of water provided from at least one source and preparing a subterranean formation treatment fluid based on the analysis of the water sample, in simplified form, in accordance with an aspect of the disclosure;

FIGS. 2A and 2B illustrate phases of operation of a microfluidic mixing cell and spectrophotometer, as well as other optional components, to determine the concentration of analyte(s) in a water sample, in accordance with the disclosure;

FIG. 3 illustrates a method for preparing and pumping a treatment fluid essentially simultaneous with measuring a detectable characteristic of an analyte in source water and adjust the relative amounts of components mixed in preparing the treatment fluid, in accordance with some aspects of the disclosure;

FIG. 4 graphically illustrates typical calibration curves and their sensitivities for the different techniques, according to an aspect of the disclosure;

FIG. 5 graphically illustrates the reproducibility of the sensitivity of the current device and manual measurements;

FIG. 6 graphically depicts a comparison of the color development of the boron/carminic acid reaction at measurement time for the manual and automated current device methods;

FIG. 7 graphically depicts the potential interference of NO₃⁻ which may be contained in samples measured using the current device; and,

FIG. 8 graphically illustrates boron analyte concentration determined in field water samples using the current device and other techniques.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability. In the summary and this detailed description, each numerical value should be read once as modified by the term “about” (unless already expressly so modified), and then read again as not so modified unless otherwise indicated in context. Also, it should be understood that a range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Some method embodiments are directed to producing treatment fluids, such as fracturing fluids, based on the well site analysis of water from one or more sources. In their most basic form, some methods achieve a goal by providing at least one water sample, analyzing the water sample for types and quantities of contaminants or other impurities, and formulating a fracturing fluid composition based thereon. As used herein, the terms “contaminants” and “impurities” may be used interchangeably to include any non-water molecule components found in the water sample. Additionally, as used herein, the location proximate to the well site can be a remote laboratory facility accessible to the operator of the well site without substantial loss of well operating time. As those of ordinary skill in the art will appreciate from the disclosure that follows, there are many different ways of analyzing the water samples for types and quantities of contaminants or other impurities, and many different ways of formulating a treatment fluid composition.

The inventors have discovered that use of microfluidic techniques to analyze water from one or more sources is rapid, and requires a small amount of sample and reagent. Since this technique uses laminar flow regime and small diffusion path length, it is more repeatable, reproducible, and less susceptible to operator errors. The technique has small footprint and is therefore suitable for onsite and mobile applications. The technique also poses less health and safety risks due to the very small volumes of material being used. Microfluidics enable miniaturization and utilization of many phenomena that dominate the small scale physics. By reducing the size of the flow path, the diffusion length is reduced, and therefore reactions occur more rapidly. Furthermore, the flow regime is contained within the bounds of laminar flow, which leads to more repeatable and reproducible reactions and measurements.

In some aspects of the disclosure an instrument for performing chemical analysis is provided as part of methods to analyze water samples as part of a treatment fluid preparation and delivery operation. The instrument operates analogously to standard techniques of analytical chemistry where visually observed titration of acid with standard base solution in presence of a colored indicator, and color change indicates a transition, or the colorimetric determination of the concentration of a species in aqueous solution, or the like. The instrument does the chemical mixing and processing with significant efficiency due to the use of a microfluidic flow cell for mixing. The observations can be made in the same flow cell or an adjacent optical cell. Some advantages include high reproducibility of tests, small sample volumes, greatly reduced cycle time for the measurement, higher precision of measurement, better accuracy of measurement, and increased sensitivity compared with standard laboratory bench tests. The instrument may have several parallel microfluidic devices simultaneously performing different small experiments.

Some embodiments of the disclosure may use valves and/or pumps to manipulate the various liquids that are combined and mixed in the microfluidic device. The microfluidic cell itself may be transparent to light and can be organized and structured in a variety of ways to afford (1) a controlled path length for fluid flow that exerts a specific shear/mixing energy on the liquid(s), and (2) a controlled optical/voltammetric cell of known dimensions for measuring the parameter of interest (e.g. fluorescence, absorption, conductivity). In addition, the cell, which is selected to be small, and made of sturdy resilient material, which may be heated and pressurized quickly and reliably. These two factors can contribute positively to reduced cycle time in measurement, and are frequently more accurately representative of actual field conditions for measurements that need to simulate wellbore conditions.

Methods may utilize such instruments for the on-location analysis of source water which is produced or flowback water. In some aspects, an operator would obtain a sample of water for analysis and a small amount of the water would be introduced to a reservoir in the instrument. In some other aspects, a sample of water may be pumped from the source, and a small amount of the water would be introduced into a reservoir in the instrument. The instrument useful in some method embodiments includes a plurality of additional reservoirs for various chemical reagents that are appropriate for the various analyses to be performed. The instrument's control function includes an instruction set appropriate to each of the analyses that are required—for example, in the analysis of boron, the protocol as outlined by D. L. Callicoat & J. D. Wolszon in Anal. Chem., 1959, 31 (8), pp 1434-1437, incorporated herein in its entirety, is to acidify the sample with sulfuric acid and then age the mixture in the presence of excess carminic acid. The intensity of color of the resulting boron-carminic acid complex is compared to a calibration curve which allows for direct evaluation of concentration of boron. These steps are automated into the instrument, thus removing operator error as a variable—the device would add a pre-acidified carminic acid solution to the sample and mix in the microfluidic channel. The colored solution would exit the mixing channel and fill the view cell, where color intensity is determined by an inexpensive spectrophotometer (i.e. a diode, a single-wavelength device, and the like). If required, the calibration curve can also be automated. By extension, several different workflows for different ions or chemical species in solution can be automated in parallel. Where there is overlap in the workflows, the same components may be used if the overall work process allows this. Also, It will be understood by one of ordinary skill in the art that other conventional analysis techniques may be employed to analyze the water sample in an efficient and simplistic manner at or proximate the well site. One non-limiting example includes analyzing light transmittance. In such an analysis, an optical reader, such as a colorimeter or filter photometer, is used to evaluate the color reaction according to the transmitted light method. A light beam is passed through the sample, and the amount of light transmitted depends on the amount of color present in the sample. For example, if the sample is very dark in color, limited light will pass through, which indicates a high analyte concentration. Other suitable detection techniques are within the scope of the disclosure, including, but not limited to, near infrared (NIR), fluorescent spectroscopy, resistivity, and the like.

Some embodiments of the disclosure also relate to techniques used for treating hydrocarbon-bearing subterranean formations—such as to increase the production of oil/gas from the formation and more particularly, a process for treating a subterranean formation by optimizing fluids for and even during treatment. Subterranean formation treatments include, but are not limited to, fracturing, acidizing, wellbore cleanout, gravel packing, acid diversion, cementing, fluid loss control, placing a pill, and the like. The techniques may also be applied to preparation and delivery of drilling mud and completion fluids. Some methods in accordance with the disclosure employ continuous real time analysis of boron concentration in supplied aqueous medium useful for blending with viscosifying agents or other components rheology model that directly describes the chemical reactions that occur in a crosslinked viscosifying agent based treatment fluid. One example of such a fluid is a borate-crosslinked guar-based fracturing fluid.

As used herein, the term “flowback” will be understood to mean the process of allowing fluids to flow from the well following a treatment, either in preparation for a subsequent phase of treatment or in preparation for cleanup and returning the well to production. One example of treatment employed within the scope of the disclosure is hydraulic fracturing. The term “hydraulic fracturing” as used herein refers to the injection of a viscous or slickwater fracturing fluid into a subterranean formation or zone at a rate and pressure sufficient to cause the formation or zone to break down with the attendant production of one or more fractures. The continued pumping of the viscous fracturing fluid extends the fractures, and a proppant such as sand or other particulate material may be suspended in the fracturing fluid and introduced into the created fractures. The proppant material functions to prevent the formed fractures from closing upon reduction of the hydraulic pressure which was applied to create the fracture in the formation or zone whereby conductive channels remain through which produced fluids can readily flow to the well bore upon completion of the fracturing treatment.

Depending on the water source, the sample of water can contain contaminants or other impurities subject to analysis, or otherwise termed “analytes”, where the contaminants can originate from natural sources or man-made sources. For example, a sample of water taken from a water source utilized in high-viscosity fracturing operations can contain gellants in the form of polymers with hydroxyl groups, such as guar gum or modified guar-based polymers; cross-linking agents including borate-based, titanium-based or zirconium-based cross-linkers; non-emulsifiers; and sulfate-based gel breakers in the form of oxidizing agents such as ammonium persulfate. A sample of water taken from a water source utilized in drilling fluid treatments can include acids and caustics such as soda ash, weighting agents such as barite, calcium carbonate, sodium hydroxide and magnesium hydroxide, bactericides, defoamers, emulsifiers, filtrate reducers, shale control inhibitors, deicers including methanol and thinners and dispersants. Also, a sample of water taken from a water source utilized in slickwater fracturing operations can include viscosity reducing agents such as polymers of acrylamide.

Water samples can include other impurities from one or more water sources that can influence the relative amounts of ingredients used to prepare treatment fluids. In at least one embodiment, the water sample includes one or more impurities from the group of boron, iron, iodine, calcium, sulfate, nitrate, nitrate, chloride, phosphate, magnesium, potassium, strontium, aluminum, bicarbonate, hydroxide, carbonate, arsenic, barium, bromine, chromium, cobalt, copper, manganese, nickel, silica, titanium, vanadium, zinc, zirconium, alkalinity, pH, and combinations thereof. Such impurities may naturally occur in the water source or may be introduced by activities related to oil and natural gas production. The water sample can include impurities having a buffering capacity of about 2 to about 3.5. Optionally, the water sample can include impurities having a buffering capacity of about 6.0 to about 7.2. Optionally, the water sample can include impurities having a buffering capacity of about 7.8 to about 8.8. In an alternate embodiment, the water sample includes impurities having organic content. In measurements made in embodiments of the disclosure, any suitable reagent useful for measuring a detectable characteristic may be used, including, but not limited to carminic acid, ferrozine, o-phenanthroline, chronotropic acid, Griess reagent, vanadomolybdate, o-cresolphthalein, calgamite, tannic acid, methylene blue, hydroxyanthraquinone, phenolphthalein, thymol blue, bromocresol, and any combinations thereof.

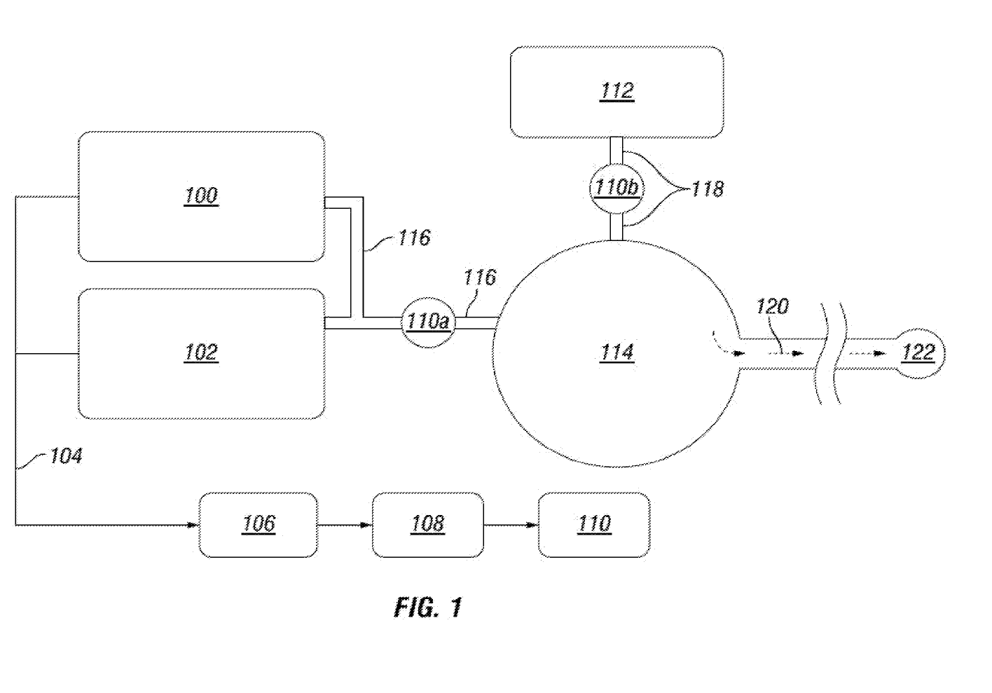

Now referencing FIG. 1, wherein a method for analyzing a sample of water provided from at least one source and preparing a subterranean formation treatment fluid based on the analysis of the water sample is depicted in simplified form, and is not necessarily limited to the scale shown in the illustration. In the embodiment depicted, a water sample sourced from one or more water sources (100, 102) can be provided 104 where the water sources (100, 102) may be separate and distinct, or the water sources (100, 102) comingle. The water source(s) (100, 102) can include water generated by oil and natural gas production, water utilized in the production of oil and natural gas, water transported to the well site, fresh water from a nearby source and the like. Non-limiting examples of a water source include water produced from the formation, flowback, steam injections, waterflooding, drilling mud, water tanks, and the like. The water source may be generated from the well site. Optionally, the water source may be generated from a neighboring well site, from a pipeline, or from a water tank transported to the well site. Those of ordinary skill in the art will understand the foregoing to be non-limiting examples, and other water sources may be considered within the scope of the disclosure.

In FIG. 1, a water sample is physically provided 104 for analysis at any suitable location, such as but not limited to a well site, or at a location proximate the well site, and the water sample includes at least one analyte, a substance to be identified and concentration measured. The water sample is introduced, or otherwise injected, into a microfluidic mixing cell 106 along with a reagent produce a mixture of the reagent and the water sample. The mixture has a detectable characteristic indicative of concentration of the at least one analyte in the water sample. The detectable characteristic is measured by spectrophotometry 108 to determine the concentration 110 of the at least one analyte. In some aspects, the injecting into the microfluidic mixing cell 106 and the measuring by spectrophotometry 108 to determine the concentration 110 are conducted over an elapsed time period of about 5 minutes or less, about 4 minutes or less, about 3 minutes or less, about 2 minutes or less, or even about 1 minute or less. In some embodiments, the mixture of the reagent and water sample are passed through an optical cell concurrent with the measuring the detectable characteristic by spectrophotometry 108, where the optical cell and spectrophotometer are arranged in an integrated unit.

Based upon the identification and concentration 110 of analyte(s) determined, the relative amounts of water from one or more water sources (100, 102) and other components 112 (only one shown) introduced into mixing system 114 can be controlled at points 110a (in delivery conduits 116) and 110b (in conduits 118). A subterranean formation treatment fluid 120 including water from the at least one water source (100, 102) and other components 112, having desired fluid properties may then be introduced into wellbore 122 at sufficient pressure to treat the subterranean formation adjacent the wellbore at a target zone.

While FIG. 1 depicts water sample analysis through one microfluidic mixing cell 106 coupled with a measurement by spectrophotometry 108 to determine the concentration 110 of the at least one analyte, it is within the scope of the disclosure in some cases to utilize a plurality of microfluidic mixing cells to conduct a plurality of measurements to ascertain the concentration of multiple analytes. Any suitable number of arrangements may be used, for example two, three, four, or up to any Nth integer of arrangements. To illustrate, a water sample and an Nth reagent may be injected into up to a Nth microfluidic mixing cell to produce a mixture of the Nth reagent and water sample, the mixture including a Nth detectable characteristic indicative of concentration an Nth analyate in the water sample. The Nth detectable characteristic may be measured by spectrophotometry to determine concentration of the Nth analyte, and a subterranean formation treatment fluid prepared from the at least one water source based on the concentration of the at least one analyte and the Nth analyte. Such Nth number of instrumental analyses may be conducted in series, parallel or combination of both.

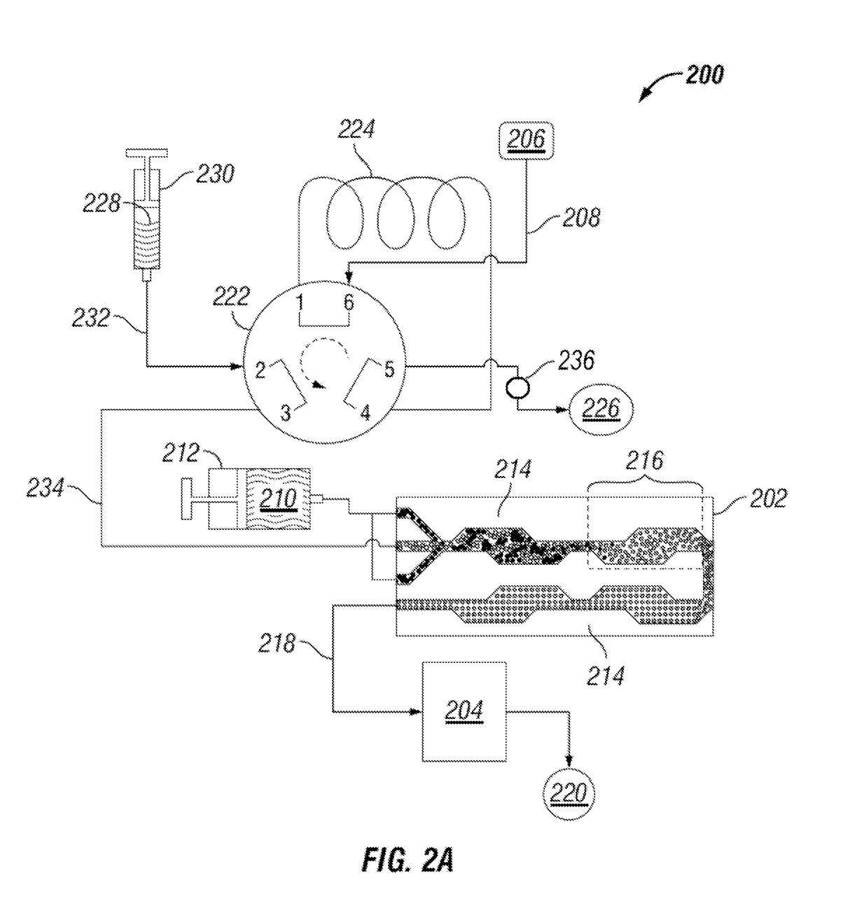

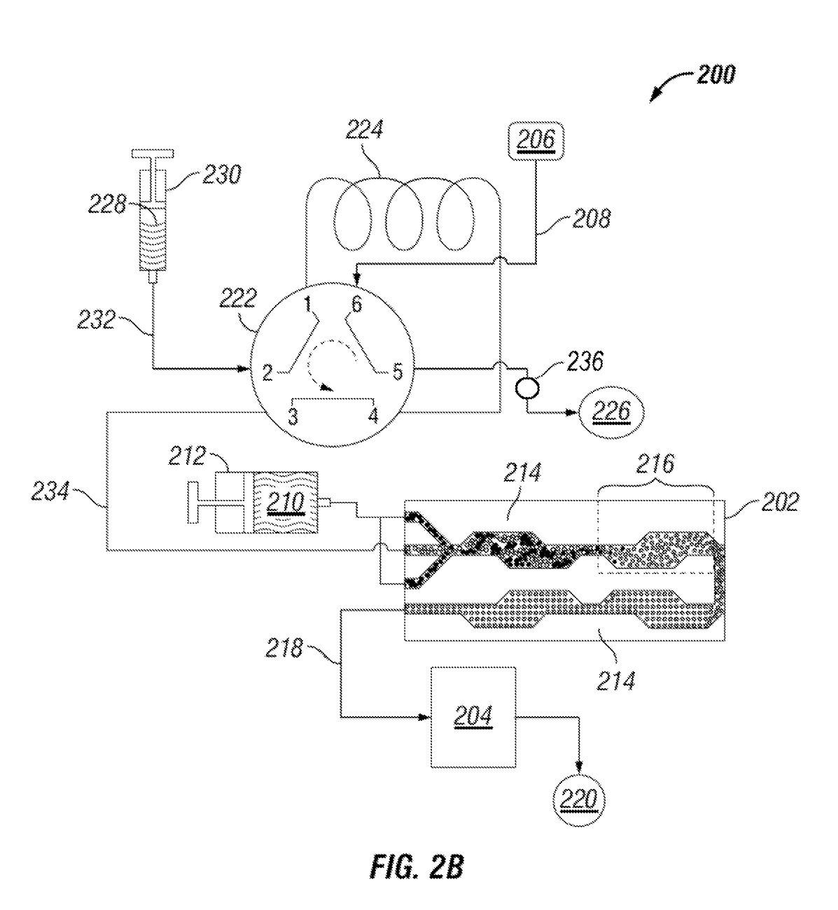

Now referring to FIGS. 2A and 2B, which illustrate some phases of operation of a microfluidic mixing cell and spectrophotometer, as well as other optional components, to determine the concentration of analyte(s) in a water sample, and are not necessarily limited to the scale shown in the illustration. Arrangement 200 shown in FIGS. 2A and 2B includes microfluidic mixing cell 202 (which may in some aspects be the same as 106 in FIG. 1) and optical cell 204, which may be integrated with a spectrophotometer to measure detectable characteristics of an analyte, such as by spectrophotometry 108 depicted in FIG. 1. Alternatively, optical cell 204 may be useful to ascertain detectable characteristics of an analyte visually. In yet another alternative embodiment, Alternatively, the observations or spectrophotometric measurements can be made in microfluidic mixing cell 202.

A water sample 206 is introduced into conduit 208, and ultimately a specific volume of sample 206 is injected into microfluidic mixing cell 202. Likewise, a specific volume of reagent 210 is injected into microfluidic mixing cell 202 by device 212. Water sample 206 and reagent 210 pass through microfluidic mixing cell 202 to produce a substantially homogenous mixture of reagent 210 and water sample 206, in a short period of time enabling unexpected elapsed time periods between introduction of the water sample and measuring the detectable characteristic(s), such periods being about 5 minutes or less, or even as low as about 1 minute or less.

To further illustrate benefits provided by arrangement 200, the mixing and processing is achieved with significant efficiency due to the use of a microfluidic mixing cell 202. As the constituent water sample 206 and reagent 210 travel simultaneously through the channel 214, significant intermixing of the constituents occurs, which is exhibited at region 216. The microfluidic mixing cell 202 may be a lamination-based compact glass microfluidic device that allows rapid mixing of two or three fluid streams in each of the two independent mixing geometries. Substantially homogenous mixing can be achieved with the system at both high as well as low flow rate ratios. The microfluidic mixing cell 202 has excellent chemical stability, high visibility (allowing access for optics), and good optical transmission. The microfluidic mixing cell 202 performs exceptionally fast, works in continuous flow mode and achieves total mixing of two or more fluid streams within milliseconds. In some embodiments, physical dimensions of microfluidic mixing cell 202 enable significant miniaturization and mobility of the arrangement. Some benefits include field deployment, real-time operation relative treatment fluid preparation, high reproducibility of tests, small sample volumes, greatly reduced cycle time for the measurement, higher precision of measurement, better accuracy of measurement, and increased sensitivity in comparison with standard bench tests.

Referring again to FIGS. 2A and 2B, in one embodiment, after mixing water sample 206 and reagent 210 travel simultaneously through microfluidic mixing cell 202, the substantially homogenous mixture is delivered to optical cell 204 by conduit or passageway 218. The optical cell 204 and the microfluidic mixing cell 202 can be integrated in the same lamination-based compact glass microfluidic device. As described above, optical cell 204 may be integrated with a spectrophotometer to measure detectable characteristics of an analyte. In some embodiments of the disclosure, the analyte is boron and the reagent, carminic acid. The intensity of color of the resulting boron-carminic acid complex may be compared to a calibration curve which allows for direct evaluation of concentration of boron. These steps may be automated into arrangement 200, thus removing operator error as a variable. In such an embodiment, the device would combine the sample with carminic acid solution 210 and mix in the microfluidic mixing cell 202. The colored solution would exit the microfluidic mixing cell 202 and fill the optical cell 204, where detectable color characteristics are determined by a spectrophotometer (such as a diode, a single-wavelength device, and the like). After the mixture is measured, it may be passed to a waste collection vessel 220 for proper handling. The level of absorption of select light wavelengths may be indicative of concentration of boron analyte when compared with the calibration curve. Such concentration may then be used to more precisely prepare a subterranean treatment fluid to achieve desired fluid properties. If required, the calibration curve can also be automated. By extension, several different workflows for different ions or chemical species in solution can be automated in parallel. Where there is overlap in the workflows, the same components may be used if the overall work process allows this.

As described above, in some embodiments, the device or arrangement 200 the device only injects and mixes the reagent with the water sample, and waiting is not required. Then the reagent and water sample 206 are mixed in the microfluidic mixing cell 202. This may be achieved by introducing water sample 206 into a rotating valve 222 through conduit 208 into port 6 of rotating valve. Water sample 206 then passes through a sample loading loop 224 fluidly connected with ports 1 and 4 of rotating valve 222, as depicted in FIG. 2A. Excess water sample 206 is directed to the waste collection vessel 226 from port 5 for proper handling, since a select volume of water sample 206 is desired in the analysis conducted. In the configuration depicted in FIG. 2A, water sample 206 is isolated from microfluidic mixing cell 202 and optical cell 204. A carrier fluid 228 may be injected into rotating valve 222 by device 230 through conduit 232 at port 2, then into conduit 234 from port 3, and onto inlet ports of microfluidic mixing cell 202. Within microfluidic mixing cell 202, the reagent 210 and carrier fluid 228 homogenously combine to produce a mixture of the reagent and the carrier fluid. The mixture is then delivered to optical cell 204 by conduit or passageway 218, and measured by spectrophotometry or observed, to determine a baseline measurement. Optical fibers may be used in some cases to bring the light to the optical cell and spectrophotometer. In some aspects, device 200 may further include a back pressure element 236.

Rotating valve 222 may advance to a next position as depicted in FIG. 2B. In this position, water sample source 206 is isolated from ports 1, 2, 3 and 4 of rotating valve 222. The volume of water sample resident in sample loading loop 224 and rotating valve 222 through ports 1 and 4 in FIG. 2A, is now made available for injection through port 6 of rotating valve 222, into conduit 234 and into microfluidic mixing cell 202. The water sample, in some aspects, may be combined, or even transmitted through the arrangement by carrier fluid 228 and device 230. Within microfluidic mixing cell 202 the water sample and reagent homogenously combine to produce a mixture of the reagent and the water sample. The mixture is then delivered to optical cell 204 by conduit or passageway 218, and measured by spectrophotometry or observed, to measure a detectable characteristic indicative of concentration of the at least one analyte in the water sample.

The events illustrated above and shown in FIGS. 2A and 2B may be repeated in some cases, as many times as appropriately required. The methodology may be conducted over an elapsed time period of about 5 minutes or less, about 4 minutes or less, about 3 minutes or less, about 2 minutes or less, or even about 1 minute or less.

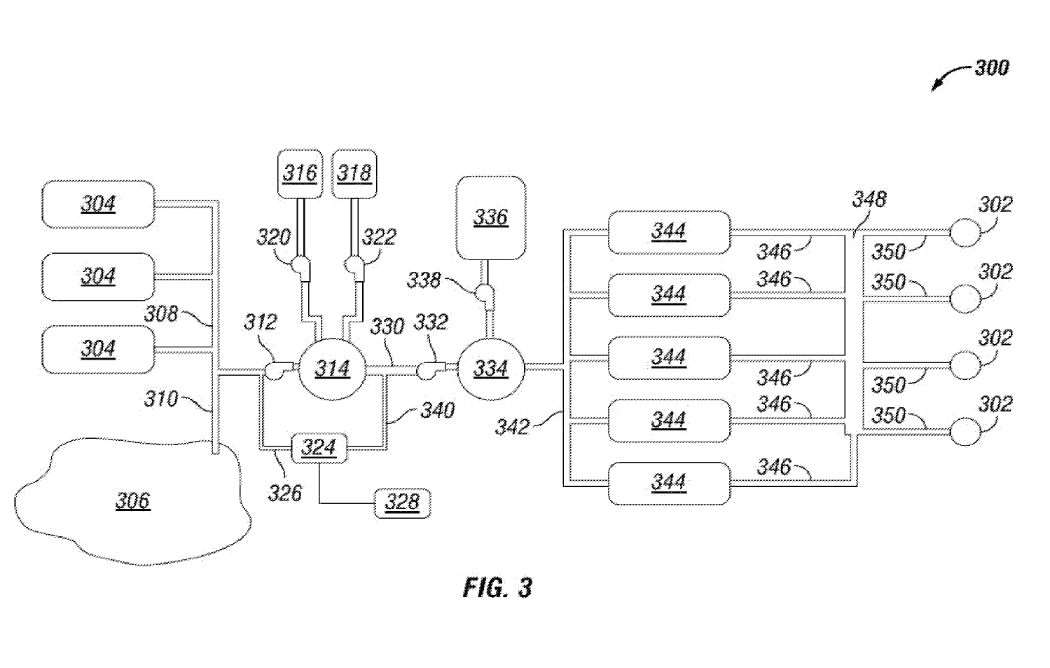

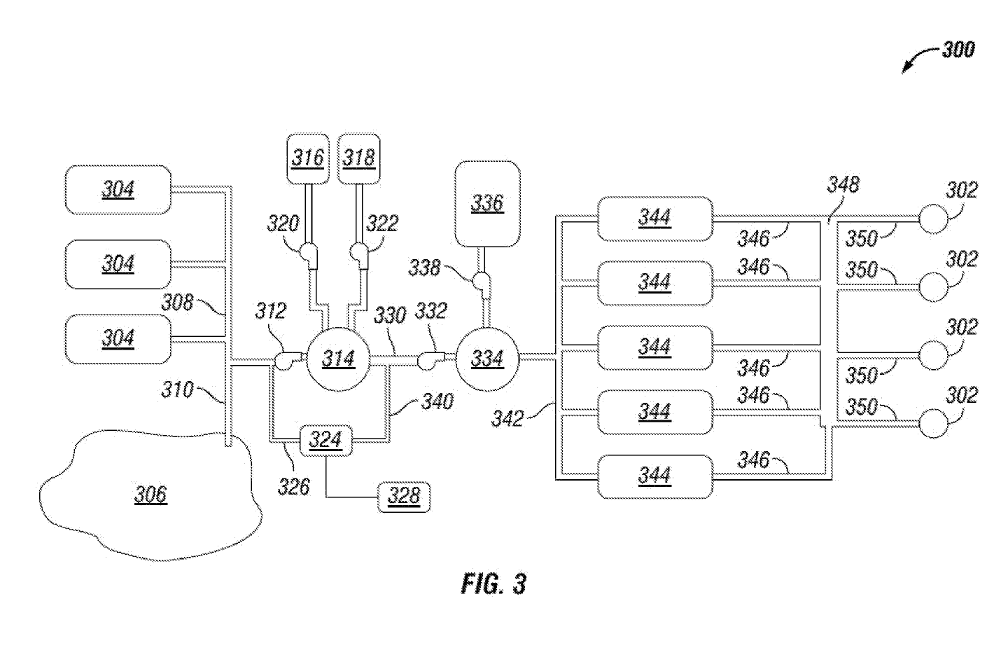

Now referring to FIG. 3, which illustrates a method for preparing and pumping a treatment fluid essentially simultaneous with measuring a detectable characteristic of an analyte in source water and adjust the relative amounts of components mixed in preparing the treatment fluid, and is not necessarily limited to the scale shown in the illustration. A well site, 300, may have one or more wellbores 302 penetrating a subterranean formation, through which treatment fluid with targeted properties may be pumped in order to treat target zones in the formation adjacent the wellbore(s). The wellbores may be treated individually, or simultaneously, at least one water source (304, 306) is provided at a suitable location, such a well site or at a location proximate the well site. The water may be sourced from a container 304, or reservoir 306, which may be surface or subterranean. The at least one water source (304, 306) contains at least one analyte, and is transported as an aqueous stream 308 through pipe system 310. Aqueous stream 308 may be moved by C-pump 312, or any other suitable device, through conduit system 310, and delivered into mixer 314 and a targeted flow rate. Mixer 314 may also be in fluid connection with one or more additional component additive sources (316, 318), where the rate of component additive is controlled by device (320, 322). The aqueous stream is also delivered to an arrangement 324 containing at least one microfluidic mixing cell and an optical cell/spectrophotometer, which may be like or similar to those arrangements described above, and in FIGS. 1, 2A and 2B. The aqueous stream, containing a water sample from the at least one water source (304, 306) is conveyed via conduit 326 from pipe system 310. Within arrangement 324, the water sample and a reagent are injected into a microfluidic mixing cell to produce a mixture of the reagent and water sample, where the mixture has a detectable characteristic indicative of concentration of the at least one analyate in the water sample. The detectable characteristic may be measured in the optical cell by spectrophotometry to determine concentration of at least one analyte in the water source (304, 306). The mixing one or more additional components from additive sources (316, 318) in mixer 314 with aqueous stream 308, may be controlled and amounts added based on the determined concentration of the at least one analyte. An optional controller 328 may be in communication with arrangement 324, as well as devices 312, 320 and 322.

In an embodiment, the analyte contained in water source (304 and/or 306) is a crosslinker, such as borate ions, and at least one component is supplied from additive sources (316, 318) which is crosslinkable with the crosslinker. For example, guar, or its derivatives are commonly known as crosslinkable with borate ions. In the case that a guar, or guar derivative, and borate crosslinker are supplied from additive sources (316, 318) for mixing in mixer 314 with water from water source (304 and/or 306), and where a select ratio of the two components is important, measuring and understanding the borate ion content in water supplied from the water source(s) is very advantageous. Understanding the borate ion content in water mixed with the viscosity controlling additive components, such as borate ions and guars, allows more precise tailoring of the treatment fluid composition to achieve desired fluid properties for the treatment. An advantage of performing the measurement of the analyte in the method set forth above include a real time, or near real time, assessment of analyte content, in order to tailor the treatment fluid composition. Additionally, any variation in analyte content in the water source(s) as they are streamed into the mixer over time, may be detected as well. Further, unexpected spikes or sharp increases in fluid viscosity may be avoided, or curtailed, thus minimizing damage to the mixing, pumping equipment, piping and/or wellbore.

Referring again to FIG. 3, after mixing the water and additive components in mixer 314, the resultant mixture may be transfer through pipe 330 by suitable device 332 (such as a C-pump) into an optional blender 334. Within blender 334, the resultant mixture may be blended with a solid particle, such as proppant, sourced from container 336. Device 338 may be useful to regulate and transfer the solid particles to blender 334. Prior to delivering the resultant mixture through pipe 330 to blender 334, in another aspect, a sample of the resultant mixture may be delivered to arrangement 324 by conduit 340. In such an embodiment, the resultant mixture is injected through the microfluidic mixing cell to further mix and then be measured in the optical cell by spectrophotometry to determine concentration of the at least one analyte after mixing in mixer 314. Such a measurement may be useful for quality assurance or control purposes, to further adjust the component additive amounts from sources (316, 318) and/or aqueous stream 308 delivery rate. Also, understanding the analyte(s) concentration in the resultant mixture may be useful in controlling the amount of solid particle delivered from container 336 to be mixed with the resultant mixture, in blender 334.

While generally a mixer 314 and blender 334 are depicted in FIG. 3, any suitable blending and mixing equipment, known to those of skill in the art, may be used in embodiments according to the disclosure. The mixer 314 may be a precision continuous mixer (PCM), often used in preparation of fracture fluids for on-the-fly mixing, and the blender 334 may be a programmable optimal density (POD) blender capable of blending and pumping proppant slurry. Also, a liquid additive system may be used in connection with the mixer and blender to add additional constituents in the preparation of the treatment fluid.

Referring again to FIG. 3, after blending the resultant mixture and solid particle in blender 334, a treatment fluid is produced. The treatment fluid is then transferred through piping array 342 to one or more pumps 344 (five shown). Any suitable number of pump units may be used, in accordance with the disclosure. The pumps are typically triplex or quintuplex pumps, which are positive-displacement reciprocating pumps configured with plungers, commonly driven by diesel engines. Triplex pumps are the most common configuration of pump used in both drilling and well service operations, and are useful for handling a wide range of fluid types, including corrosive fluids, abrasive fluids and slurries containing relatively large particulates. Pumps 344 pressurize the treatment fluid to a first pressure, and deliver the treatment fluid through pipes 346 to pressure manifold 348. Pressure manifold 348 further increases the treatment fluid pressure to target pressure required for treating the target zone in the formation adjacent wellbore(s) 302. The treatment fluid is then injected into one or more of wellbores 302 through pipes 350. In some aspects, the use of arrangement 324 as an integral component in the preparation and delivery of the treatment fluid to the subterranean formation target zone better ensures the treatment fluid viscosifying components are fully crosslinked, partially crosslinked, or uncrosslinked, depending upon the stage of the treatment, as the proper amount crosslinking agent is incorporated into the fluid.

In another embodiment of the disclosure, another method of preparing a subterranean formation treatment fluid is provided. With reference to FIG. 3, an aqueous stream 308 is delivered from at least one water source (304, 306) to a mixer 314. A water sample from the at least one water source (304, 306), is provided to arrangement 324, by operator sampling or a sample port connected to conduit 326. In arrangement 324, the water sample containing at least one analyte and a reagent are injected into a microfluidic mixing cell to produce a mixture of the reagent and water sample. The mixture has a detectable characteristic indicative of concentration of the at least one analyte in the water sample. The detectable characteristic is measured by spectrophotometry to determine concentration of the at least one analyte. Based upon this determination, one or more additional components from sources (316, 318) are combined in mixer 314 with the aqueous stream 308, in an amount based, at least in part, upon the measured concentration of the at least one analyte. A treatment fluid containing water from the at least one water source and the one or more additional components are delivered into a wellbore penetrating a subterranean formation. The injecting into the microfluidic mixing cell and the measuring by spectrophotometry are conducted over a time period of about 5 minutes or less, or even about 1 minutes or less.

As depicted in FIGS. 1 through 3, a microfluidic mixing cell and an optical cell (used with either visual or spectrophotometric measurements) are used to ascertain the concentration of at least one analyte in a water source or fluid mixture. Based upon the measurement(s), a fluid composition may then be formulated or confirmed. In some aspects, once measured, the analyte(s) concentration matrix profile may be entered into a portion of a predictive fluid modeling system. The analyte(s) concentration may be automatically entered upon generation by the analytical procedure. For example, the analyte(s) concentration may be generated in electronic data format compatible with the formulation database, where the electronic data from the analyte(s) concentration may be sent upon generation to the formulation database. Such transmittal may be accomplished by conventional methods known to one of ordinary skill in the art. Optionally, the analyte(s) concentration may be entered manually by an operator of the well site, where the data from the analyte(s) concentration may be entered by keyboard or other conventional methods known to those skilled in the art.

In some embodiments, data regarding information and properties of the well to be treated and desired properties of the oilfield fluid composition are entered into the formulation database. The well data may be entered manually utilizing methods discussed above regarding the analyte(s) concentration or the data may be entered automatically through the use of sensors or other electronic methods. For example, the formulation database may be in electronic communication with sensors capable of determining well temperature and pressure. Optionally, the data may be entered automatically, manually, and or in combinations thereof. Well data entered into the formulation database for the well to be treated can include temperature and pressure. Desired fluid properties of the oilfield fluid composition can also be entered, wherein the desired fluid properties can include pH, initial viscosity, viscosity delay slope, final broken viscosity, sand transport time, onset of crosslinking, type of gelling agent, type of crosslinker, type of breaker, types of other additives (scale inhibitor), type of biocide, type of paraffin control, type of clay control, and combinations thereof.

In another embodiment, the formulation database generates a fluid model, wherein the fluid model can be utilized to formulate a fluid composition, which will be discussed in further detail below. The formulation database includes physical and chemical properties related to the analytes and the well to be treated. The formulation database can also include fundamental physical and chemical relationships, empirical evidence, algorithms based on testing results, and the like. In an embodiment, the formulation database is in an electronic format and can be located on a computer at the well site. Optionally, the formulation database can be hosted on a remote server accessible by a computer located at the well site.

The formulation database may generate a fluid model utilized to formulate a fluid composition. Specifically, the fluid model provides a recommendation on the composition of the formulation fluid to be used. The recommendation can include concentration of gelling agent, concentration of crosslinker, concentration of buffers, concentration of breaker, concentration of other additives, and combinations thereof. The fluid model may be generated in various formats. In an embodiment, the fluid model may be generated in a spreadsheet format, a report format, a graphical format, a tabular format, and combinations thereof. The fluid model can be in an electronic format and can be located on a computer at the well site. Optionally, the formulation database can be hosted on a remote server accessible by a computer located at the well site. The computer can be operatively connected to at least one fluid producing device, wherein one or more signals generated by the computer in reference to the fluid model can include instructions on fluid composition to be generated by the fluid producing device.

In an exemplary embodiment, at least one recommendation included in the fluid model generated by the formulation database is acted upon by the operator of the well site to produce a fluid composition suitable for use as a fracturing fluid. In an embodiment, the fracturing fluid will have one or more of the following properties configured according to the recommendations provided in the oilfield fluid model: pH, initial viscosity, viscosity delay slope, final broken viscosity, sand transport time, onset of crosslinking, type of gelling agent, type of crosslinker, type of breaker, types of other additives (scale inhibitors), type of biocide, type of paraffin control, type of clay control, and combinations thereof.

Formation and downhole pressure and temperature can have an impact on fluid rheology. In the case of pressure, when there is adequate pressure present in the treatment or delivery environment, the effective crosslinking functionality of a crosslinking agent, such as a borate, may be significantly reduced. Such pressures are those on the order of magnitude of 10³ psi or greater, such 4×10³ psi or greater. At 4×10³ psi, measured viscosity is about half of the viscosity of a borate crosslinker at ambient surface pressure. Thus, the pressure affects on a borate crosslinker can be taken into account in some embodiments, and methodologies in accordance with the disclosure further improved the precision in prepared borate crosslinked treatment fluids.

Methods of the invention may also be useful for real-time QA/QC of the fluids, thus making possible to adjust the fluid components during an operation to achieve a further optimized fluid and treatment schedule. As described above, a rheology model can be used to further extrapolate monitored surface characteristics such as viscosity, pumping rate, temperature, polymer concentration, crosslinker concentration, breaker concentration to bottom-hole conditions.

In addition to preparing a treatment fluid, such as a fracturing fluid, embodiments of the disclosure may be useful for generating measurements could be used for measuring boron, or any other applicable analytes, in such processes involving ground water analysis, stock tank analysis, boron removal for environmentally friendly discharge, preparing drilling fluid, cementing fluid, acidizing fluid, completion fluid, gravel packing fluid, and the like, as well as wellbore flow back testing and environmental measurements and monitoring. The measurement could be used as a “live” measurement with a feedback loop to control the flow and chemicals, or in a batch mode prior to injection as well.

The following examples are presented to illustrate the use and some benefits of microfluidic mixing cells with optical cells, and should not be construed to limit the scope of the disclosure, unless otherwise expressly indicated in the appended claims. All percentages, concentrations, ratios, parts, etc. are by weight unless otherwise noted or apparent from the context of their use.

### Examples

In a first example, a microfluidic based instrument (also referred to as “current device” or “current system” herein) was constructed for the detection of analytes, such as boron, in aqueous media, and compared to existing commercial methods. The boron value of four field water samples was measured in the instrument and compared against ICP-MS results. The current device was constructed having components generally described in FIGS. 2A and 2B. A flow injection analysis (FIA) instrument, which uses a carrier fluid (double distilled water or milliQ) to push a water sample and reagent (such as carminic acid) into a microfluidic mixer, was used. Optical absorption was measured in a Starna flow cell using a tungsten light source and a spectrometer (HR4000, Ocean Optics). The current device used in the following examples incorporated a rotating valve (VICI, Valco) to permute between sample and carrier solution. The pumps were Kloehn V6 syringe pumps equipped with a 1 ml and 5 ml syringes. Flow rates were 30 to 150 μl for the carrier pump and 90 to 750 μl for the reagent syringe. The flow rate ratio between the two pumps was kept at 1 (carrier) to 3 (reagent) (1:3 (v:v) to maintain the optimum color development. Alternatively, a 1:5 (v:v) mixing ratio could also be used. Sample was loaded manually in the injection loop. A back pressure element providing at least 4 bars of back pressure and consisting of a tubing of 0.01 inch ID and appropriate length was integrated at the waste side of the instrument. This allowed for gases generated by the reaction of sulfuric acid with the salt rich water sample to stay dissolved in the solution, thus providing an optical signal free of interferences (i.e. bubbles). Additionally, the back pressure element may help avoid or diminish unwanted plugging or clogging within the microfluidic chip when excessive outgassing of the mixed solution evaporates water and precipitates the salts in solution. A LabView 2011 (National Instrument) computer interface was developed to control the various components and to record the relevant data.

A carminic acid method was used which is a colorimetric assay where the chemical reaction between boron and the acid induces a color change in the solution (see Callicoat, 1959; Gupta and Boltz, 1974). For boron and a 10 mm absorption path, the color developed can be measured at wavelengths between 575 nm and 750 nm with a sensitivity decreasing with the increasing wavelength. Based on the carminic acid assay, a three factor improvement in sensitivity was observed. For a similar end of reaction absorption, a much shorter development time is observed: about 1 minute versus 30 minutes. High sensitivities (6.30×10⁻² a.u/ppm) with good reproducibility (1% at 95% confidence), a low limit of detection (0.2 ppm) and a 3.5% precision characterize the instrument and method of using. The instrument was capable of determining boron in samples containing up to 40000 mg/l of chloride over a range of 0-500 ppm [B]. With higher back pressure, determining boron in samples containing chloride concentrations higher than 40000 mg/l is possible. Interferences from ionic species are reported and experimentally quantified for the nitrate case. The carminic acid method proved to be highly sensitive to boron.

Samples and carminic acid reagent were mixed in the microfluidic mixer and the color change was recorded with the spectrophotometer. Light absorption of the solution at a specific wavelength (610 nm±1 nm) was proportional to the boron concentration (in accordance with Beer-Lambert's law). The results listed in Table 1 were obtained at ambient temperature. A 1 cm absorption flow cell with a mixing ratio of carminic acid to sample of 5:1 (v:v) was used. Sensitivity, limit of detection and measuring range are scalable with the path length of the cell. Definition of the terminology used in table 1 can be found in the International Vocabulary of Metrology (VIM) report by the Joint Committee for Guides in Metrology (JCGM_200_2008 VIM.pdf).

TABLE 1

| Attribute | Value | Comments |
|---|---|---|
| Precision as repeatability | 4% | Triplicate under similar conditions (operator, reagent batch, |
| | | 10.0 ± 0.1 ppm B standard) |
| Precision as | 3.5% | Determined on n = 24 measurements of 10.0 ± 0.1 ppm B |
| reproducibility | | standards (4 reagents, 24 freshly prepared standards, |
| | | measured on 8 different days) |
| Limit of detection (LOD) | 0.2 ppm | 3 times the standard deviation on the blank as per the IUPAC |
| | | definition |
| Sensitivity S | Typ. 6.30 × 10⁻² a.u/ppm | From a 5-point calibration |
| Reproducibility of S | 1% at 95% confidence | 4 calibration runs (fresh chemical each run), 0-20 ppm B |
| | 6.32 × 10⁻² ± 0.05 × 10⁻² a.u/ppm | |
| Measuring range | 0 to 500 ppm | |
| Color development time | <2 min | At ambient temperature (20° C.) |
| Measurement duration | <2 min(blank and sample) | |
| Known interferences | See Table 2 below | |
| Reagent lifetime | >60 days | <5% change in 10 ppm B measurement. Tested for 60 days |

Interferences from ionic species are reported and experimentally quantified for the nitrate case. The carminic acid method for the determination of boron is the least sensitive to interferences (Callicoat, 1959; Lòpez et al., 1993). False positives and negatives in presence of high concentrations of certain ionic species (nitrate, strong oxidants, transition metals) are nonetheless reported (Aznarez et al., 1985; Gupta and Boltz, 1974; Lòpez et al., 1993; Ross and White, 1960). Table 2 summarizes the most common interferences reported in the literature. When applicable, masking agents and concentration limits are given.

TABLE 2

| | | Limit (for 5% | | Limit (for 5% | |
|---|---|---|---|---|---|
| | Impact on | signal | | signal | |
| | signal (false | modification) | | modification) | |
| Interfering | positive or | before masking | Masking agent, | after masking | |
| species | negative) | agent | mitigation plan | agent | Carminic acid concentration |
| Nitrate NO₃⁻: | | | | | |
| Ross, 1960 | Negative | <0.4 × 10⁻³M | Formic and sulfuric | 3M | 0.1% (w/v) in H₂SO₄ |
| | | | acid reflux | | |
| Lionnel, 1970 | Negative | <10 mg/l | 0.25% HCl | 20 mg/l | 1 g/l in H₂SO₄ |
| Lionnel, 1970 | Negative | <10 mg/l | 0.5% Phenol | 40 mg/l | 1 g/l in H₂SO₄ |
| Gupta, 1974 | X | 2 mg/l | N/A | N/A | 1 g/l diluted to 0.018% |
| Rosenfeld, | Function of | X | Hydrazine | 10000 mg/l | 0.125 g/l in H₂SO₄ |
| 1979 | [NO₃⁻] | | | | |
| Aznarez, 1985 | X | N/A | B extraction with 1-6M | 0.15M | 0.01% in 1:2 (v/v) sulfuric/acetic |
| | | | HCl and TMPD* in | | acid |
| | | | chloroform | | |
| Iron: | | | | | |
| Fe²⁺: | | | | | |
| Gupta, 1974 | X | 0.4 mg/l | N/A | N/A | 1 g/l diluted to 0.018% |
| Aznarez, 1985 | X | N/A | Prior extraction of Fe | 0.05M | 0.01% in 1:2 (v/v) sulfuric/acetic |
| | | | with methyl isobutyl | | acid |
| | | | ketone | | |
| Fe³⁺: | | | | | |
| Aznarez, 1985 | X | N/A | Prior extraction of Fe | 0.05M | 0.01% in 1:2 (v/v) sulfuric/acetic |
| | | | with methyl isobutyl | | acid |
| | | | ketone | | |
| Fe (Ross, | Positive | <1 g | N/A | N/A | 0.1% (w/v) in H₂SO₄ |
| 1960) | | | | | |
| Mo⁶⁺: | | | | | |
| Gupta, 1974 | X | 20 mg/l | N/A | N/A | 1 g/l diluted to 0.018% |
| Aznarez, 1985 | X | N/A | TMPD* | 0.1M | 0.01% in 1:2 (v/v) sulfuric/acetic |
| | | | | | acid |
| K⁺: | | | | | |
| Aznarez, 1985 | X | N/A | TMPD* | 0.15M | 0.01% in 1:2 (v/v) sulfuric/acetic |
| | | | | | acid |
| Mg²⁺: | | | | | |
| Gupta, 1974 | X | 400 mg/l | N/A | N/A | 1 g/l diluted to 0.018% |
| Aznarez, 1985 | X | N/A | TMPD* | 0.15M | 0.01% in 1:2 (v/v) sulfuric/acetic |
| | | | | | acid |
| Ca²⁺: | | | | | |
| Aznarez, 1985 | X | N/A | TMPD* | 0.15M | 0.01% in 1:2 (v/v) sulfuric/acetic |
| | | | | | acid |
| Cl⁻: | | | | | |
| Gupta, 1974 | X | 400 mg/l | N/A | N/A | 1 g/l diluted to 0.018% |
| Aznarez, 1985 | X | N/A | TMPD* | 7.5M | 0.01% in 1:2 (v/v) sulfuric/acetic |
| | | | | | acid |
| F⁻: | | | | | |
| Gupta, 1974 | X | 0.08 mg/l | N/A | N/A | 1 g/l diluted to 0.018% |
| Aznarez, 1985 | X | N/A | Aluminium | 0.01M | 0.01% in 1:2 (v/v) sulfuric/acetic |
| | | | | | acid |
| Br⁻: | | | | | |
| Gupta, 1974 | X | 20 mg/l | N/A | N/A | 1 g/l diluted to 0.018% |
| Cu²⁺: | | | | | |
| Gupta, 1974 | X | 4 mg/l | N/A | N/A | 1 g/l diluted to 0.018% |
| Aznarez, 1985 | X | N/A | TMPD* | 0.1M | 0.01% in 1:2 (v/v) sulfuric/acetic |
| | | | | | acid |

X: not reported
*TMPD: 2,2,4_trimethyl-1,3-pentanediol,
TMPD*: 1-6M HCl extraction in chloroform using TMPD.

With the exception of nitrate (Rosenfeld and Selmer-Olsen, 1979), the quantitative relationship between the interferent and the carminic acid was not studied, and only limits were reported. The sensitivity to pH and the use of buffers to control the pH of the sample were noted (Evans and Krahenbühl, 1994).

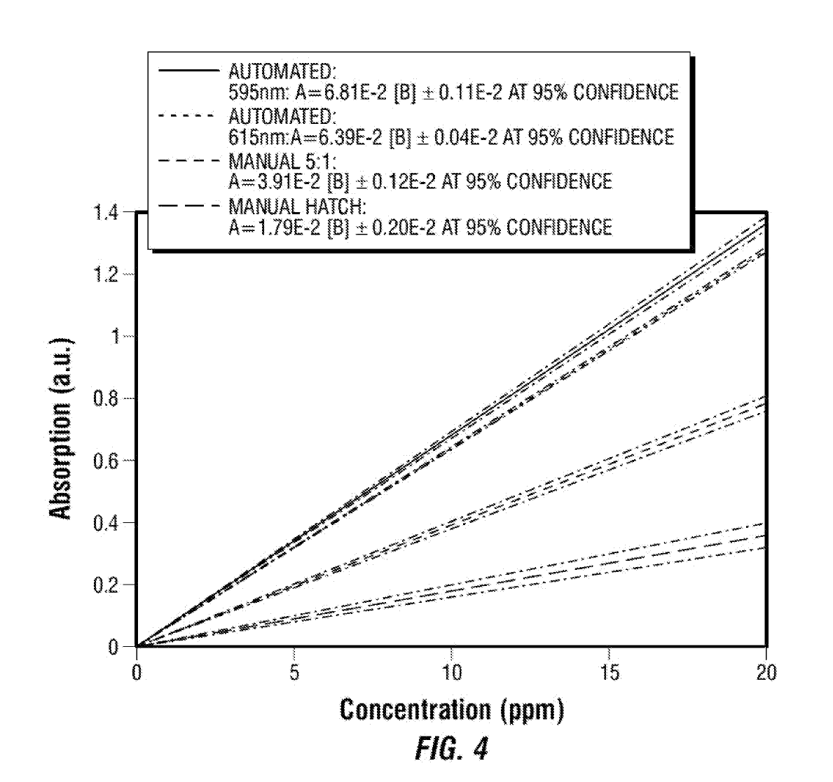

In another example, sensitivity and reproducibility of the sensitivity are compared. The sensitivity S of a technique is defined as the absorption change (a. u.) induced by a 1 ppm concentration variation. This value can be expressed in a. u./ppm or in ppm⁻¹ and corresponds to the slope of the calibration curve when plotting absorption versus concentration, as shown in FIG. 4. FIG. 4 graphically illustrates typical calibration curves and their sensitivities for the different techniques. The sensitivity improvement in the current device compared with Hach chemistry is greater than three-fold. The sensitivity of the current device may even be increased further by measuring at 595 nm instead of 610 nm but to the expense of the precision. In all cases, the device useful for methods according to the disclosure proved the best precision (repeatability).

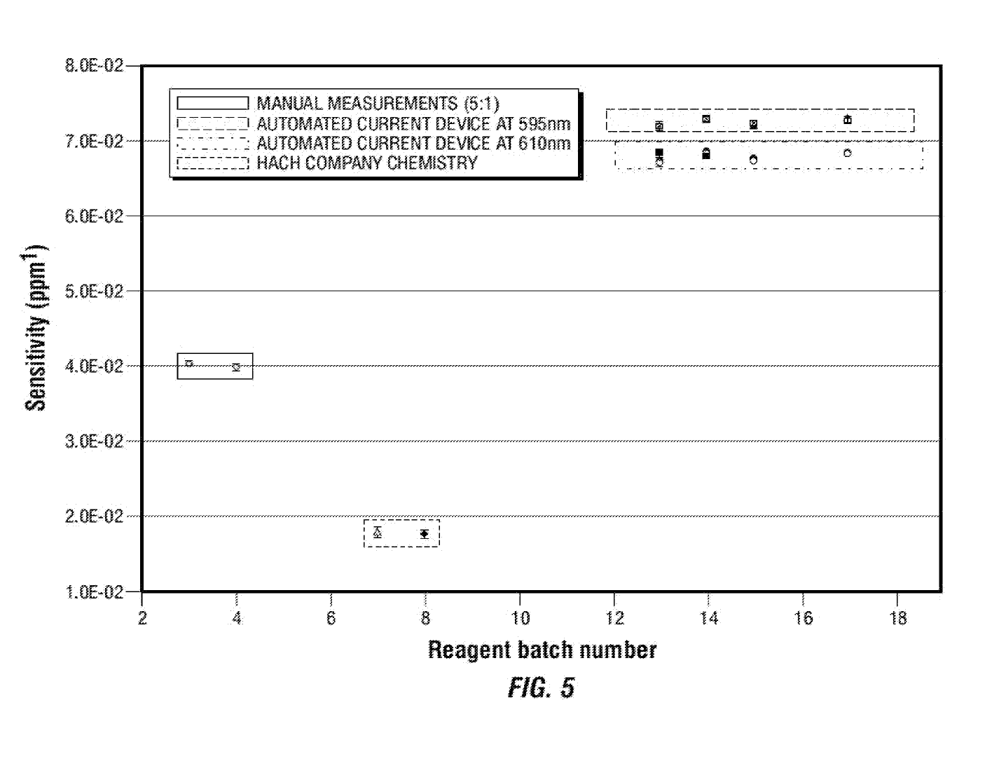

The reproducibility of the sensitivity of the current device or system and manual measurements is represented FIG. 5. A reproducibility of 1% was found for the automated system. Variations in the preparation of the reagent of less than 5% in weight of carminic acid and/or 5% in volume of acid did not impact the sensitivity by more than 1%.

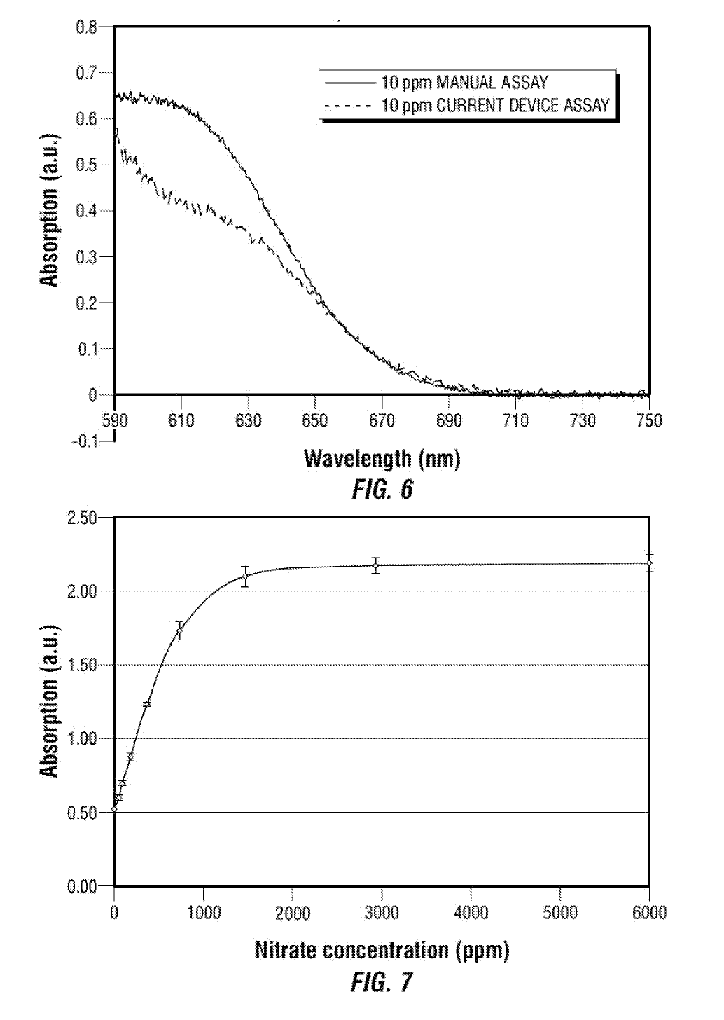

In another example, the measurement time and affect thereof, were evaluated. For the current device, with a development time seven times shorter than typical manual methods, the color change was 50% higher at 610 nm (see FIG. 6). This improvement is attributed to the microfluidic mixing cell which 1) enhances the diffusion by improving the contact surface between the sample and reagent, and 2) allows for the reaction to happen at low ambient temperature (mixing acid and water is an exothermic reaction, high temperatures are detrimental to the short term sensitivity of the assay), and in a much shorter elapsed time period. FIG. 6 graphically depicts a comparison of the color development of the boron/carminic acid reaction at measurement time for the manual and automated current device methods. The color development of the manual method is recorded after 15 minutes, while the current device (automated) records the color change after 2 minutes (residence time). For a development time seven times shorter, the color change in the current device is 50% higher (at 610 nm).

In another example, due to the nature of some of the waters to be measured, chloride concentrations can be relatively high, in the order of 50-60 g/l for the average water sample and higher than 200 g/l. In this study, NaCl was added incrementally to a 10 ppm boron standard and then measured using the current device with a 6 bar back pressure element. For [Cl⁻]<100,000 mg/l, no chemical interferences were observed. However, the air bubbles (HCl) generated by the reaction of sulfuric acid with the salt impaired the optical measurement. No reliable data could be collected for [Cl⁻]>100,000 mg/l. Nitrate ions were also evaluated. Nitric acid was used as a nitrate (NO₃) standard and added to a 10 ppm B standard to study its impact on the carminic acid complex absorption (Ross and White, 1960). A strong false positive (15% signal change for a 50 ppm NO₃⁻ addition) was observed as shown in FIG. 7.

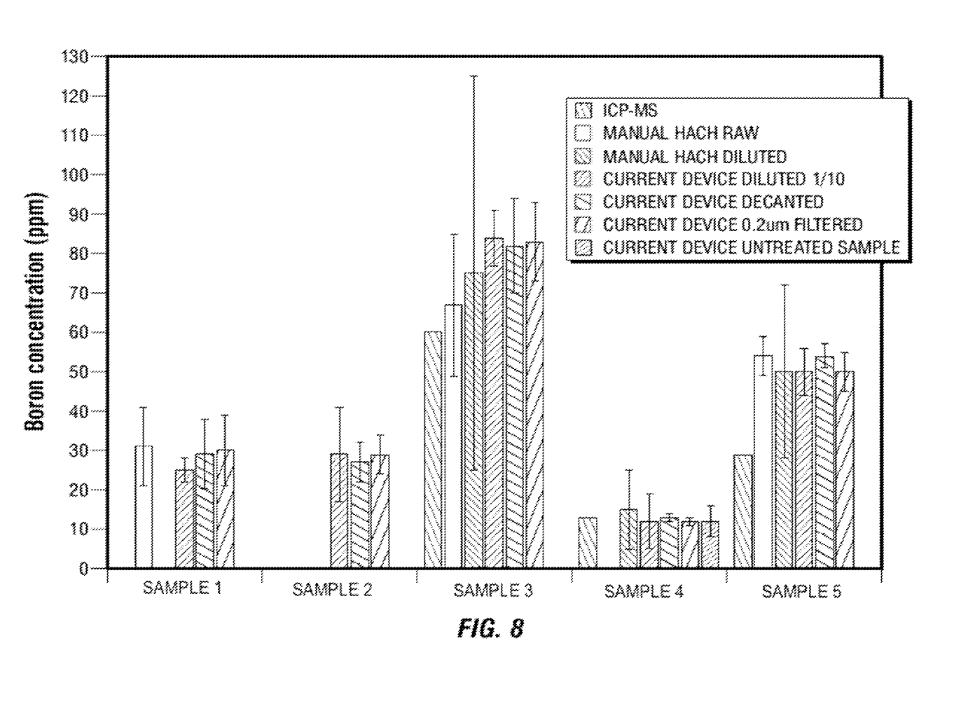

In yet another example, boron analyte concentration was determined in oilfield water samples using the current device, according to some method embodiments of the disclosure. Four different water samples with their certificate of analysis from an external laboratory were tested using the current device. Results and comparison against other techniques are presented in FIG. 8. Each manual and current device value is the result of triplicate measurement with error bars representing the 95% confidence interval. As shown, the low [Cl⁻] content of Sample 4 allowed for its direct determination without prior dilution and thus comparison against results obtained after dilution. No statistically meaningful difference was observed. The smaller standard deviation on the 10× diluted measurement could be explained by the reduced interferences from HCl bubbles. Sample 1 was sub-sampled twice (Sample 1 and Sample 2) at different time intervals. Measurements were performed on the same day with the same reagent. Filtering, sampling the decanted phase of the fluid or diluting the sample tenfold did not impact the results of the current device. The over evaluating trend of the current device could indicate the presence of interferences in the high ionic content samples.

The effect of filtering (0.2 μm pre-filtering) and decanting of the sample were also evaluated. The influence was found to be insignificant. However, agitating the sample before measurement and pre-filtering may be useful to avoid particles blocking the passages in the microfluidic mixing cell of the current device.

Chemicals used in the foregoing examples were sourced and handled as follows: carminic acid, 99.999% sulfuric acid and boric acid were sourced from Sigma Aldrich; and, deionized water was supplied by ThermoScientific. To prevent contamination from borosilicate glass each solution was prepared and stocked into plastic vessels. Sulfuric acid resistant bottles (polymethylpentene, PMP) and graduated cylinders were used to store the reagent. The colorimetric reagent was prepared by dissolving 276 mg of carminic acid in 250 ml of 99.999% sulfuric acid and left overnight to fully dissolve. A 1-litre boron stock solution (1,000 ppm) was prepared by dissolving 5.6364 g of boric acid in deionized water. Serial dilutions of the stock solution provided the daily prepared working standards (0-200 ppm).

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus used in methods to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A method comprising:
providing a water sample for analysis, wherein the water sample is collected from at least one water source and wherein the water sample comprises at least one analyte;
injecting the water sample and a reagent into a microfluidic mixing cell to produce a mixture of the reagent and water sample, the mixture comprising a detectable characteristic indicative of concentration of the at least one analyate in the water sample;
measuring the detectable characteristic by spectrophotometry to determine concentration of the at least one analyte;
preparing a subterranean formation treatment fluid comprising the at least one water source based on the concentration of the at least one analyte;
wherein the injecting and the measuring are conducted over an elapsed time period of about 5 minutes or less.

2. The method of claim 1 further comprising injecting the water sample into a rotating valve and passing the water sample through a sample loading loop fluidly connected with the rotating valve, then injecting the water sample and a reagent into the microfluidic mixing cell, wherein the elapsed time period between the injecting the water sample into the rotating valve and the measuring is about 5 minutes or less.

3. (canceled)

4. The method of claim 1 further comprising:
injecting a carrier fluid and the reagent into the microfluidic mixing cell to produce a mixture of the reagent and the carrier fluid;
measuring the mixture of the reagent and the carrier fluid by spectrophotometry to a determine a baseline;
wherein the mixture of the reagent and the carrier fluid is substantially free of the water sample.

5. The method of claim 4 wherein the injecting the carrier fluid and the reagent into the microfluidic mixing cell and the measuring the mixture of the reagent and the carrier fluid by spectrophotometry are conducted separate from the injecting the water sample and the reagent into the microfluidic mixing cell and the measuring the detectable characteristic.

6. The method of claim 5 wherein the measured baseline and the measured detectable characteristic are compared to determine concentration of the at least one analyte, and wherein the method is conducted over elapsed time period of about 5 minutes or less.

7. (canceled)

8. The method of claim 1 wherein the injecting and the measuring are conducted over an elapsed time period of about 2 minutes or less.

9. The method of claim 1 further comprising passing the mixture of the reagent and water sample through an optical cell concurrent with the measuring the detectable characteristic by spectrophotometry.

10. The method of claim 1 further comprising:
injecting the water sample and an Nth reagent into a Nth microfluidic mixing cell to produce a mixture of the Nth reagent and water sample, the mixture comprising a Nth detectable characteristic indicative of concentration of a Nth analyte in the water sample;
measuring the Nth detectable characteristic by spectrophotometry to determine concentration of the Nth analyte;
preparing a subterranean formation treatment fluid comprising the at least one water source based on the concentration of the at least one analyte and the Nth analyte;
wherein the injecting and the measuring are conducted over an elapsed time period of about 5 minutes or less.

11. The method of claim 1 wherein the at least one analyte is selected from the group consisting of boron, manganese, iron, nitrate, nitrate, sulfate, phosphate, calcium, magnesium, strontium, sulfide, zirconium, titanium, barium, alkalinity, pH, salinity and any combinations thereof.

12. The method of claim 1 wherein the reagent is selected from the group consisting of carminic acid, ferrozine, o-phenanthroline, chromotropic acid, griess reagent, vanadomolybdate, o-cresolphthalein, calgamite, tannic acid, methylene blue, hydroxyanthraquinone, phenolphthalein, thymol blue, bromocresol, and any combinations thereof.

13. A method comprising:
providing at least one water source, wherein the at least one water source comprises at least one analyte;
delivering an aqueous stream from the at least one water source to a mixer and to a microfluidic mixing cell;
injecting a water sample from the at least one water source and a reagent into a microfluidic mixing cell to produce a mixture of the reagent and water sample, the mixture comprising a detectable characteristic indicative of concentration of the at least one analyate in the water sample;
measuring the detectable characteristic by spectrophotometry to determine concentration of the at least one analyte;
mixing one or more additional components in the mixer with the aqueous stream, in an amount based on the concentration of the at least one analyte;
pumping a treatment fluid comprising the at least one water source and the one or more additional components into a wellbore penetrating a subterranean formation;
wherein the injecting and the measuring are conducted over a time period of about 5 minutes or less.

14. The method of claim 13 further comprising injecting the water sample into a rotating valve and passing the water sample through a sample loading loop fluidly connected with the rotating valve, then injecting the water sample and a reagent into the microfluidic mixing cell, wherein the elapsed time period between the injecting the water sample into the rotating valve and the measuring is about 5 minutes or less.

15. (canceled)

16. The method of claim 15 further comprising:
injecting a carrier fluid and the reagent into the microfluidic mixing cell to produce a mixture of the reagent and the carrier fluid;
measuring the mixture of the reagent and the carrier fluid by spectrophotometry to a determine a baseline;
wherein the mixture of the reagent and the carrier fluid is substantially free of the water sample.

17. The method of claim 16 wherein the injecting the carrier fluid and the reagent into the microfluidic mixing cell and the measuring the mixture of the reagent and the carrier fluid by spectrophotometry are conducted separate from the injecting the water sample and the reagent into the microfluidic mixing cell and the measuring the detectable characteristic.

18. The method of claim 17 wherein the measured baseline and the measured detectable characteristic are compared to determine concentration of the at least one analyte.

19. The method of claim 18 wherein the injecting and the measuring are conducted over an elapsed time period of about 1 minutes or less.

20. The method of claim 13 wherein the injecting and the measuring are conducted over an elapsed time period of about 1 minutes or less.

21. The method of claim 13 further comprising passing the mixture of the reagent and water sample through an optical cell concurrent with the measuring the detectable characteristic by spectrophotometry.

22. The method of claim 13 further comprising:
injecting the water sample and an Nth reagent into a Nth microfluidic mixing cell to produce a mixture of the Nth reagent and water sample, the mixture comprising a Nth detectable characteristic indicative of concentration of the at least one analyate in the water sample;
measuring the Nth detectable characteristic by spectrophotometry to determine concentration of the Nth analyte;
mixing one or more additional components in the mixer with the aqueous stream, in an amount based on the concentrations of the at least one analyte and the Nth analyte;
wherein the injecting and the measuring are conducted over an elapsed time period of about 5 minutes or less.

23. A method of preparing a subterranean formation treatment fluid, the method comprising:
delivering an aqueous stream from at least one water source to a mixer;
providing a water sample comprising at least one analyate from the at least one water source, and injecting the water sample and a reagent into a microfluidic mixing cell to produce a mixture of the reagent and water sample, the mixture comprising a detectable characteristic indicative of concentration of the at least one analyate in the water sample;
measuring the detectable characteristic by spectrophotometry to determine concentration of the at least one analyte;
mixing one or more additional components in the mixer with the aqueous stream, in an amount based on the concentration of the at least one analyte;
pumping a treatment fluid comprising the at least one water source and the one or more additional components into a wellbore penetrating a subterranean formation;
wherein the injecting and the measuring are conducted over a time period of about 5 minutes or less.
